(19) United States
(12) Patent Application Publication
(10) Pub. No.: US 2025/0189814 A1
(43) Pub. Date: Jun. 12, 2025

(54) AUGMENTED REALITY GLASSES FRAME, METHOD FOR PREPARING AUGMENTED REALITY GLASSES FRAME, AND AUGMENTED REALITY GLASSES

(71) Applicant: GOERTEK TECHNOLOGY CO., LTD., Qingdao (CN)

(72) Inventors: Pengfei WANG, Qingdao (CN); Liang FAN, Qingdao (CN)

(21) Appl. No.: 19/060,951

(22) Filed: Feb. 24, 2025

Related U.S. Application Data
(63) Continuation of application No. PCT/CN2023/124768, filed on Oct. 16, 2023.

(30) Foreign Application Priority Data
Oct. 27, 2022 (CN) 202211328716.5

(51) Int. Cl. G02C 5/00; G02B 27/01

(52) U.S. Cl. CPC G02C 5/008; G02B 27/017; G02B 2027/0178

(57) ABSTRACT

An augmented reality, AR glasses frame, a method for preparing an AR glasses frame, and AR glasses. The AR glasses frame includes a main body and an appearance part. The main body is made of magnesium-lithium alloy, and a shielding layer is provided at an inner side surface of the main body. The appearance part is made of metal, the appearance part is connected to an outer side surface of the main body, and a decorative layer is provided at a surface of the appearance part away from the main body. A decorative protective layer is provided at peripheral side surfaces of the main body and the appearance part.

### CROSS-REFERENCE TO RELATED APPLICATIONS

This application is a continuation application of International Application No. PCT/CN2023/124768, filed on Oct. 16, 2023, which claims priority to Chinese Patent Application No. 202211328716.5, filed on Oct. 27, 2022. The disclosures of the above-mentioned applications are incorporated herein by reference in their entireties.

### TECHNICAL FIELD

The present application relates to the technical field of augmented reality (AR) product, and in particular to an AR glasses frame, a method for preparing an AR glasses frame, and AR glasses.

### BACKGROUND

Wearable augmented reality glasses, namely AR glasses, can project virtual scenes or content into the real world. The wearable AR glasses are considered to be hardware devices with great development potential that can replace smartphones in the future. At this stage, the wearable AR glasses have received widespread attention from a large number of high-tech companies. For AR glasses, the key factor affecting their development and popularization is the weight of the whole machine, and the relatively heavy weight makes it difficult for consumers to wear them all day long. Therefore, the shell material of AR glasses is particularly important and is the key factor in achieving weight reduction of the whole machine. At present, commonly used AR glasses frame materials are plastic or metal. Among metal materials, the magnesium-lithium alloy is the metal structural material with the lowest known density, so it has great application potential in the field of wearable consumer electronics that pursues extreme lightweight.

However, at this stage, magnesium-lithium alloy AR glasses frames can usually only use traditional surface treatment processes, such as micro-arc oxidation or spraying. The appearance texture obtained by such processes is poor, lacks metallic luster, has a poor feel, and is of low grade, making it difficult to increase the added value of terminal products. The lack of high-grade metal texture of magnesium-lithium alloy greatly limits the application scope of magnesium-lithium alloy in the emerging AR consumer electronics field. Therefore, how to achieve metal texture treatment on the surface of magnesium-lithium alloy AR frames while maintaining its lightweight advantage is a powerful means to further expand the application scope of magnesium-lithium alloys.

### SUMMARY

The main purpose of the present application is to provide an AR glasses frame, aiming to obtain an AR glasses frame with good appearance texture effect and lightweight.

To achieve the above purpose, the AR glasses frame proposed by the present application includes:
a main body, the main body is made of magnesium-lithium alloy, and a shielding layer is provided at an inner side surface of the main body; and
an appearance part, the appearance part is made of metal, the appearance part is connected to an outer side surface of the main body, and a decorative layer is provided at a surface of the appearance part away from the main body; and
a decorative protective layer is provided at peripheral side surfaces of the main body and the appearance part.

In an embodiment, a thickness range of the appearance part is 0.02 mm to 0.2 mm, and/or, a thickness range of the main body is 0.4 mm to 0.6 mm.

In an embodiment, an assembly part is connected to the inner side surface of the main body, and the shielding layer is provided at an inner side surface of the assembly part and the inner side surface of the main body.

In an embodiment, a connection mode between the main body and the appearance part is hot rolling composite, welding or bonding.

And/or, the assembly part and the main body are an integrated injection molding structure.

In an embodiment, the appearance part is made of aluminum alloy, titanium alloy or stainless steel.

And/or, the assembly part is made of plastic.

And/or, the shielding layer is made of epoxy resin.

And/or, the decorative layer is made of metal oxide or ceramic.

And/or, the decorative protective layer is made of metal or resin material.

The present application further proposes a method for preparing an AR glasses frame, including:
providing a composite board including a main body and an appearance part stacked with the main body, where the main body is made of magnesium-lithium alloy, and the appearance part is made of metal;
stamping the composite board, and forming source material of a glasses frame;
spraying a shielding layer on a surface of the main body away from the appearance part;
performing surface treatment on a surface of the appearance part away from the main body, and forming a decorative layer; and
performing transition treatment on peripheral side surfaces of the main body and the appearance part, forming a decorative protective layer, and completing processing of the AR glasses frame.

In an embodiment, after the stamping the composite board and forming the source material of the glasses frame, and before the spraying the shielding layer on the surface of the main body away from the appearance part, the method further includes:
performing Nano injection molding on the source material of the glasses frame, and forming an assembly structure on the surface of the main body away from the appearance part.

In an embodiment, the shielding layer is made of epoxy resin.

And/or, the surface treatment includes anodizing, electrolytic coloring or magnetron sputtering, and the decorative layer is made of metal oxide or ceramic.

And/or, the decorative protective layer is made of metal or resin material.

In an embodiment, after the performing the surface treatment on the surface of the appearance part away from the main body, and forming the decorative layer; and before the performing the transition treatment on the peripheral side surfaces of the main body and the appearance part, the method further includes:
machining the source material of the glasses frame, and forming a cross section on the peripheral side surfaces of the main body and the appearance part; and
the performing the transition treatment on the peripheral side surfaces of the main body and the appearance part, forming the decorative protective layer is specifically to perform the transition treatment on the cross section.

In an embodiment, the transition treatment includes electroplating or electrophoresis.

In an embodiment, the appearance part is made of aluminum alloy, titanium alloy or stainless steel.

And/or, the assembly part is a plastic part.

The present application further proposes an AR glasses, including an AR glasses frame and eyeglasses temples connected to the AR glasses frame. The AR glasses frame is any one of the AR glasses frame described above, or the AR glasses frame is prepared by any one of the method for preparing the AR glasses frame described above.

In the technical solution of the present application, the AR glasses frame includes a main body and an appearance part. The main body is made of a magnesium-lithium alloy, so as to ensure the overall strength and lightweight of the glasses frame. The appearance part is arranged on the outer side surface of the main body. The appearance part is a metal part. Different from the material of the main body, its surface can be subjected to surface treatment such as anodizing, electrolytic coloring, magnetron sputtering and electroplating. The process is simpler, so as to form a decorative layer with a metallic luster and texture, thereby improving the appearance texture of the glasses frame. At the same time, a shielding layer is provided at the inner side surface of the main body, which can play a good protective role when the appearance part is subjected to surface treatment, ensuring that its surface is intact. A decorative protective layer is also provided at the end surfaces of the main body and the appearance part, which can not only play a good protective role on the surface of the glasses frame, but also make the color transition between the appearance part and the main body at the end surface natural, further improving the overall appearance aesthetic.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is an exploded view of an AR glasses frame according to an embodiment of the present application.

FIG. 2 is a longitudinal view of the AR glasses frame at one position shown in FIG. 1.

FIG. 3 is a longitudinal cross-sectional view of the AR glasses frame at another position shown in FIG. 1.

FIG. 4 is a step flow chart of a method for preparing an AR glasses frame according to an embodiment of the present application.

FIG. 5 is a step flow chart of a method for preparing an AR glasses frame according to another embodiment of the present application.

FIG. 6 is a step flow chart of a method for preparing an AR glasses frame according to yet another embodiment of the present application.

The realization of the purpose, functional features and advantages of the present application will be further explained in conjunction with the embodiments and with reference to the drawings.

### DETAILED DESCRIPTION OF THE EMBODIMENTS

The technical solutions in the embodiments according to the present application will be described below in conjunction with the accompanying drawings in the embodiments of the present application. Obviously, the described embodiments are only some of the embodiments of the present application, but not all of the embodiments. Based on the embodiments of the present application, all other embodiments obtained by those skilled in the art without any creative work fall within the scope of the present application.

It should be noted that, all directional indications (such as up, down, left, right, front, back or the like) involved in the embodiments of the present application are only used to explain the relative positional relationship, movement and so on between various components in a specific posture (as shown in the accompanying drawings). If the specific posture changes, the directional indication will also change accordingly.

In addition, in the present application, if there are descriptions involving “first”, “second” or the like are only for descriptive purposes and cannot be understood as indicating or implying the relative importance or implicitly indicating the quantity of the technical features indicated. Therefore, features defined as “first” and “second” may explicitly or implicitly include at least one of these features.

In addition, the technical solutions of various embodiments can be combined with each other, but it must be based on that those skilled in the art can realize. When the combination of technical solutions is contradictory or cannot be realized, it should be considered that such combination of technical solutions does not exist and is not within the protection scope claimed by the present application.

The present application proposes an AR glasses frame, which is applied to AR glasses, so as to be able to obtain an AR glasses frame with light weight, beautiful appearance and good overall protection.

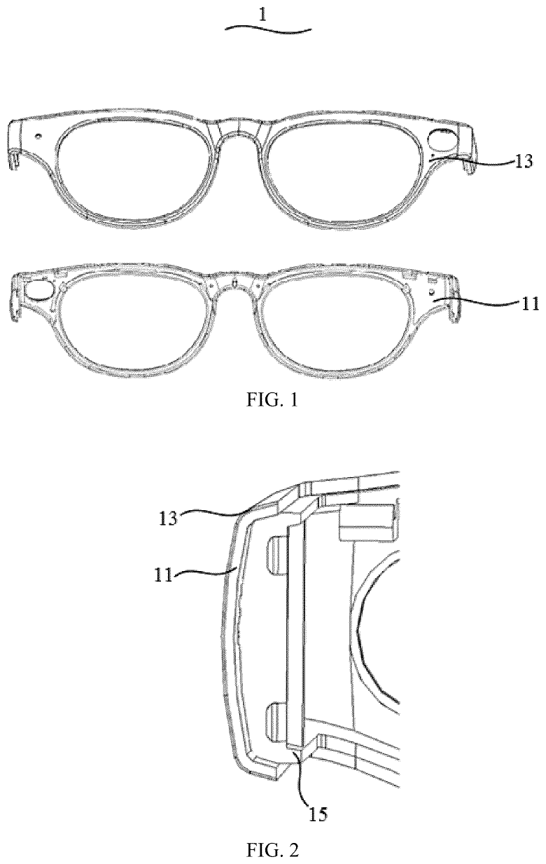

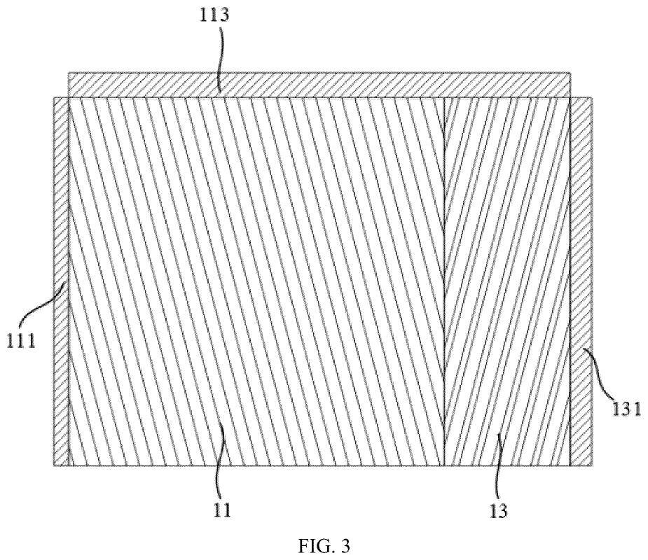

Referring to FIG. 1 and FIG. 3, in an embodiment of the present application, the AR glasses frame 1 includes a main body 11 and an appearance part 13. The main body 11 is made of magnesium-lithium alloy, and a shielding layer 111 is provided at an inner side surface of the main body 11.

The appearance part 13 is made of metal, the appearance part 13 is connected to an outer side surface of the main body 11, and a decorative layer 131 is provided at a surface of the appearance part 13 away from the main body 11.

A decorative protective layer 113 is provided at peripheral side surfaces of the appearance part 13 and the main body 11.

It can be understood that the AR glasses frame 11 is a frame structure, which is formed with two frame structures adapted to the human eye, and has a nose wing structure connecting the two frame structures. Certainly, the structure of the AR glasses frame 1 is not limited to the above structure, and can further include a connection part connected to the temple, which is distributed on both sides of the two frame structures for easy connection.

In this embodiment, the AR glasses frame 1 includes a main body 11 and an appearance part 13 in the thickness direction, that is, the appearance part 13 is connected to the outer side surface of the main body 11. In order to ensure the lightweight of the AR glasses frame 11, the main body 1111 is made of magnesium-lithium alloy, which is the structural material with the lowest density among all metals, and can effectively reduce the weight of the AR glasses frame 11 and improve the wearing experience. The specific material ratio in the magnesium-lithium alloy is not improved here, so it is not elaborated too much, as long as it is an alloy composed of magnesium and lithium elements. The appearance part 13 is made of metal, which is different from the magnesium-lithium alloy of the main body 11, and is only used to improve the appearance effect of the main body 11. The outer side surface here refers to the inner side surface facing the face when the AR glasses frame 1 is worn on the user's head, and the outer side surface is away from the face.

Exemplarily, the appearance part 13 is made of aluminum alloy, titanium alloy or stainless steel, with high structural strength and good surface gloss, and has a good decorative effect. On this basis, in order to further improve the surface gloss effect of the appearance part 13, a surface treatment can be performed on it, so that a decorative layer 131 is covered on the surface, and a pre-designed special texture appearance effect can be obtained. Here, the material of the decorative layer 131 may vary depending on the surface treatment method of the appearance part 13. For example, when the appearance part 13 is subjected to anodizing treatment, a metal oxide layer disposed on the surface of the appearance part 13 may be obtained. In this case, the material of the decorative layer 131 is metal oxide. In an embodiment, when the appearance part 13 is subjected to magnetron sputtering treatment, a decorative layer 131 of ceramic material may be obtained. This is not limited here and may be subjected to corresponding treatment as required.

Exemplarily, while the appearance part 13 is provided with a decorative layer 131, a shielding layer 111 is formed on the inner side surface of the main body 11. The shielding layer 111 is made of epoxy resin, which has good wear resistance and waterproof performance, is green and environmentally friendly, and will not cause any impact on the human body; at the same time, it can also have good acid resistance and alkali corrosion resistance, thus avoiding affecting the structure of the main body 11 during the surface treatment of the appearance part 13, and ensuring the structural strength and stability of the AR glasses frame 1. It can be understood that the shielding layer 111 made of epoxy resin can have a lower thermal conductivity than the main body 11 made of metal and the appearance part 13 made of metal, which can effectively reduce the temperature rise of the outer side of the AR glasses frame, and avoid the bad wearing experience caused by the temperature rise. Certainly, in other examples, the inner side surface of the main body 11 can be further provided with other coatings that can effectively resist acid and alkali.

In an embodiment, because the main body 11 and the appearance part 13 are laminated composite materials, the colors and textures reflected at the peripheral side surfaces of the two are different, so a decorative protective part is provided at the peripheral side surfaces of the two, which can achieve a unified color and texture for the peripheral side surfaces, or can achieve a transition effect for the color and texture of the main body 11 and the appearance part 13; and can protect the peripheral side surfaces and improve its corrosion resistance. Exemplarily, the decorative protective layer 113 is made of metal or resin material. Different materials can be selected according to different treatment methods of the peripheral side surfaces.

In the technical solution of the present application, the AR glasses frame 1 includes a main body 11 and an appearance part 13. The main body 11 is made of a magnesium-lithium alloy, so as to ensure the overall strength and lightweight of the glasses frame. The appearance part 13 is arranged on the outer side surface of the main body 11. The appearance part 13 is a metal part. Different from the material of the main body 11, its surface can be subjected to surface treatment such as anodizing, electrolytic coloring, magnetron sputtering and electroplating. The process is simpler, so as to form a decorative layer 131 with a metallic luster and texture, thereby improving the appearance texture of the glasses frame. At the same time, a shielding layer 111 is provided at the inner side surface of the main body 11, which can play a good protective role when the appearance part 13 is subjected to surface treatment, ensuring that its surface is intact. A decorative protective layer 113 is also provided at the end surfaces of the main body 11 and the appearance part 13, which can not only play a good protective role on the surface of the glasses frame, but also make the color transition between the appearance part 13 and the main body 11 at the end surface natural, further improving the overall appearance aesthetic.

In an embodiment, a thickness range of the appearance part 13 is 0.02 mm to 0.2 mm.

And/or, a thickness range of the main body 11 is 0.4 mm to 0.6 mm

In this embodiment, since the main body 11 is the main structure of the AR glasses frame 1, its thickness should not be too large, otherwise it will affect its wearing weight, and its thickness should not be too small, otherwise the structural strength is insufficient. Therefore, in an embodiment, the thickness of the main body 11 is set to a range of 0.4 mm to 0.6 mm, for example, 0.45 mm, 0.5 mm or 0.55 mm, so as to have a relatively high structural strength while achieving a lightweight wearing experience.

Similarly, the thickness of the appearance part 13 should not be too large, otherwise it will increase the weight of the main body 11. Certainly, its thickness should not be too small, otherwise, the appearance improvement effect is not obvious and the production cost is too high. Therefore, its thickness range is set to 0.02 mm to 0.2 mm, for example, 0.04 mm, 0.06 mm, 0.08 mm, 0.1 mm, 0.12 mm, 0.14 mm, 0.16 mm or 0.18 mm, etc., which has a relatively good appearance texture while ensuring lightweight.

Referring to FIG. 2, in an embodiment, an assembly part 15 is connected to the inner side surface of the main body 11, and the shielding layer 111 is provided at an inner side surface of the assembly part 15 and the inner side surface of the main body 11.

In this embodiment, in order to facilitate the assembly of the AR glasses frame 1 with the temples and other components, an assembly part 15 is connected to the inner side surface of the main body 11. The assembly part 15 is made of plastic, so that relatively complex structures can be realized by injection molding and other methods, which is convenient for connection and assembly. The connection method between the two is not limited, for example, integrated injection molding or bonding.

In an embodiment, a connection mode between the main body 11 and the appearance part 13 is hot rolling composite, welding or bonding.

And/or, the assembly part 15 and the main body 11 are an integrated injection molding structure.

In this embodiment, in order to ensure the connection stability between the main body 11 and the appearance part 13, the main body 11 and the appearance part 13 can be connected by hot rolling composite, welding or bonding. The welding can be explosion welding or friction welding, etc., to ensure seamless fit between the two and improve structural strength and structural stability.

When the connection mode between the main body 11 and the appearance part 13 is not limited or is the above method, the connection method between the assembly part 15 and the main body 11 is set to be integral injection molding, that is, the two realize an integral structure by injection molding, which significantly improves the structural strength and connection stability.

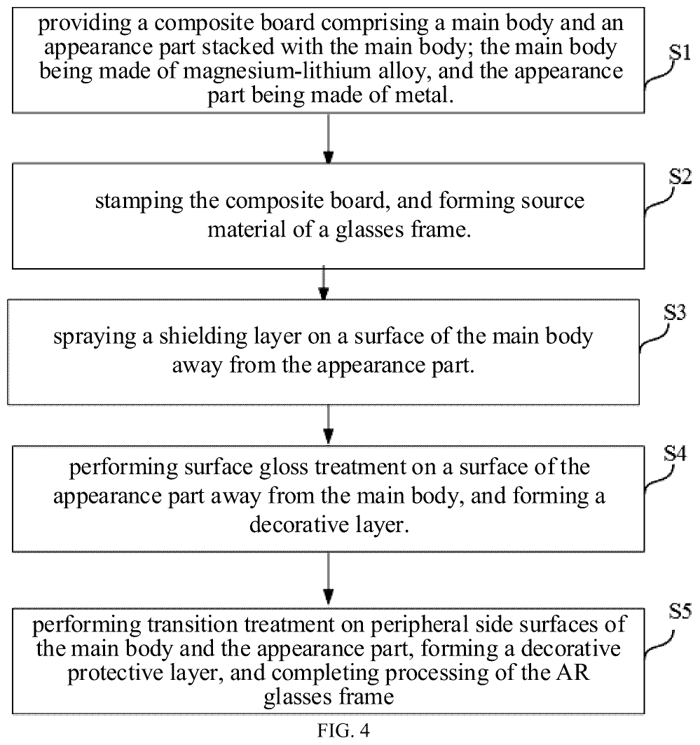

Referring to FIG. 3 and FIG. 4, the present application further proposes a method for preparing an AR glasses frame 1, the method including:
Step S1: providing a composite board including a main body and an appearance part 13 stacked with the main body 11; the main body 11 is made of magnesium-lithium alloy, and the appearance part 13 is made of metal.
Step S2: stamping the composite board, and forming source material of a glasses frame.
Step S3: spraying a shielding layer 111 on a surface of the main body 11 away from the appearance part 13.
Step S4: performing surface treatment on a surface of the appearance part 13 away from the main body 11, and forming a decorative layer 131.
Step S5: performing transition treatment on peripheral side surfaces of the main body 11 and the appearance part 13, forming a decorative protective layer 113, and completing processing of the AR glasses frame 1.

It can be understood that the AR glasses frame 1 is applied to a head-mounted device. In order to improve comfort, the head-mounted device needs to be relatively light. Therefore, in order to be lightweight, the thickness of the board selected in step S1 should not be too large. The specific size can be selected according to actual conditions. For example, the size in the above embodiment can be referred to. In this embodiment, the composite board is a composite structure of the main body 11 and the appearance part 13. The main body 11 is a magnesium-lithium alloy, because it is the structural material with the lowest density among all metals, thus being able to effectively reduce the weight of the AR glasses frame 1 and improve the wearing experience. The appearance part 13 is used to improve the appearance effect of the magnesium-lithium alloy. The appearance part's material is other metals different from the magnesium-lithium alloy magnesium-lithium alloy; for example, it can be titanium alloy, aluminum alloy or stainless steel. The composite mode of the main body 11 and the appearance part 13 is not limited here, for example, hot rolling composite, welding or bonding, etc., to ensure the tightness of the connection. It can be understood that the size of the composite board should be slightly larger than the size of the finished AR glasses frame 1 to ensure the molding effect.

In step S2, the composite board is processed and formed by stamping to obtain the source material of the glasses frame. This processing method is simple and convenient, improves processing efficiency, and ensures processing accuracy. In other embodiments, it can further be bending, forging, etc.

After completing the basic shape, in step S3, the surface treatment of the source material of the glasses frame is realized. It can be understood that because the previous processing steps will contaminate the surface of the source material of the glasses frame, in order to facilitate preparation, the surface of the source material of the glasses frame is pre-treated so that its surface meets the conditions and state of the surface treatment. Specifically, the pre-treatment can be cleaning or resetting the surface structure to improve the bonding force with the film layer, which is not limited here. For example, mechanical treatment or chemical treatment. The shielding layer 111 is set by spraying. The process is simple, easy to implement, and low in cost, and can be applied to mass production. The material strength of the shielding layer 111 should have relatively good anti-corrosion performance, thereby improving the protection of the main body 11 structure. Exemplarily, the shielding layer 111 is made of epoxy resin, which has good wear resistance and anti-corrosion performance, is green and environmentally friendly, and will not affect the human body. The spraying thickness of the shielding layer 111 can be set according to actual conditions to ensure that the inner surface is covered with the shielding layer 111.

In step S4, performing surface treatment on the appearance part 13 to form a decorative layer 131 with a better texture. Here, the material of the decorative layer 131 obtained is different according to different treatment processes. In an embodiment, the surface treatment includes anodizing, electrolytic coloring or magnetron sputtering. When anodizing is used, the decorative layer 131 is made of metal oxide, thereby forming an oxide corresponding to the material of the appearance part 13, improving the surface wear resistance and good glossiness, and further improving the appearance effect. When the surface treatment is magnetron sputtering, the material of the decorative layer 131 can be selected as ceramic, or can be metal, such as nickel, black chrome, gold or imitation gold, which can have a relatively good gloss effect. The above-mentioned plating processes are all commonly used plating processes, and the specific plating process will not be described in detail here. The thickness of the decorative layer 131 can be set as needed, for example, 3 μm to 6 μm, which saves materials and has a relatively good texture.

In step S5, performing an overall transition treatment on peripheral side surfaces of the main body 11 and the appearance part 13 so that they have a transitional state between the texture and color of the two, so as to further enhance the overall appearance texture and effect, thereby completing the preparation of the AR glasses frame 1.

In the technical solution of the present application, the AR glasses frame 1 includes a main body 11 and an appearance part 13. The main body 11 is made of a magnesium-lithium alloy, so as to ensure the overall strength and lightweight of the glasses frame. The appearance part 13 is provided at the outer side surface of the main body 11. The appearance part 13 is a metal part. Different from the material of the main body 11, the surface of the appearance part 13 can be subjected to surface treatment such as electroplating, and the process is simpler, so as to form a decorative layer 131 with a metallic luster and texture, thereby improving the appearance texture of the glasses frame. At the same time, a shielding layer 111 is provided at the inner side surface of the main body 11, which can play a relatively good protective role when the appearance part 13 is subjected to surface treatment, ensuring its surface is intact. A decorative protective layer 113 is also provided at the end surfaces of the main body 11 and the appearance part 13, which can not only play a good protective role on the surface of the glasses frame, but also make the color transition between the appearance part 13 and the main body 11 at the end surface natural, further improving the overall appearance. This production process can achieve a special texture design on the overall surface of the magnesium-lithium alloy, while retaining the lightweight effect of the magnesium-lithium alloy. The process is simple, the cost is low, and it is very suitable for industrial mass production.

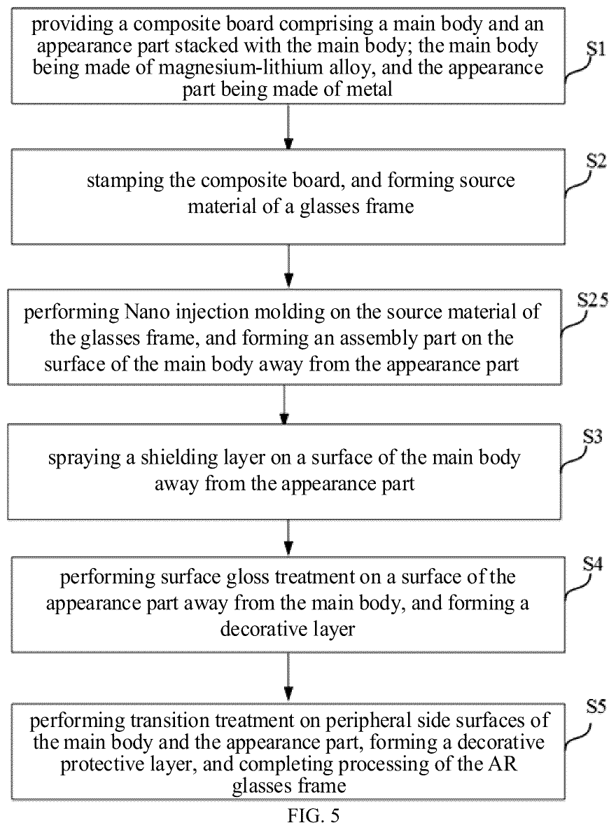

Referring to FIG. 5, in an embodiment, after the stamping the composite board and forming the source material of the glasses frame, and before the spraying the shielding layer 111 on the surface of the main body 11 away from the appearance part 13, the method further includes:
Step S25: performing Nano injection molding on the source material of the glasses frame, and forming an assembly structure on the surface of the main body 11 away from the appearance part 13.

In this embodiment, in order to facilitate the assembly of the AR glasses frame 1 with the temples and other components, an assembly structure is provided at the inner side surface of the main body 11. The assembly structure can be the assembly part 15 of the AR glasses frame 1. The assembly part 15 is made of plastic, so that a relatively complex structure can be achieved by injection molding and other methods, which is convenient for connection and assembly. Moreover, processing by nano injection molding, that is, the two are integrated into one structure by injection molding, which significantly improves the structural strength and connection stability, and can also effectively reduce the deformation of the AR glasses frame 1 to ensure support stability.

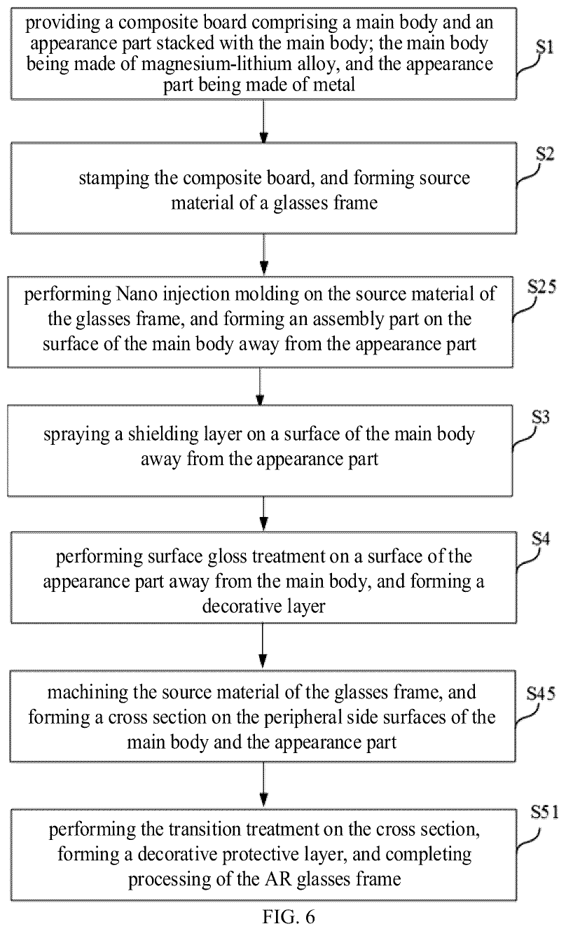

Referring to FIG. 6, in an embodiment, after the performing the surface treatment on the surface of the appearance part 13 away from the main body 11, and forming the decorative layer 131; and before the performing the transition treatment on the peripheral side surfaces of the main body 11 and the appearance part 13, the method further includes:
Step S45: machining the source material of the glasses frame, and forming a cross section on the peripheral side surfaces of the main body 11 and the appearance part 13; and
the performing the transition treatment on the peripheral side surfaces of the main body 11 and the appearance part 13, forming the decorative protective layer 113 is specifically to be step S51: performing the transition treatment on the cross section.

In this embodiment, in order to achieve the dimensional accuracy of the AR glasses frame 1, after the transition treatment on the main body 11 and the appearance part 13, performing step S45, and a lathe or other equipment may be used to machine them, for example, cutting or punching, to achieve the required size and structure and improve the structural accuracy. It can be understood that the machining position is mainly at the peripheral side surfaces of the main body 11 and the appearance part 13, so a cross section will be formed at the peripheral side surfaces of the two. Therefore, in step S51, a decorative protective layer 113 is formed on the cross section to ensure the overall appearance effect and protective effect of the AR glasses frame 1.

In an embodiment, the transition treatment includes electroplating or electrophoresis.

In this embodiment, the transition treatment of the cross section can be electroplating or electrophoresis. Electroplating can form a metal film layer at the cross section. At this time, the decorative protective layer 113 is made of metal, for example, zinc, nickel, etc., to achieve a relatively good metallic gloss texture. Alternatively, an electrophoresis process can be used to form a resin film layer at the cross section. The decorative protective layer 113 is made of resin material, so that good wear resistance, acid resistance and alkali resistance can be achieved, and the corrosion resistance of the cross section of the AR glasses frame 1 can be improved.

In an embodiment, the appearance part 13 is made of aluminum alloy, titanium alloy or stainless steel.

In this embodiment, the appearance part 13 is made of aluminum alloy, titanium alloy or stainless steel, with high structural strength and good surface gloss, and a relatively good decorative effect.

The present application further proposes an AR glasses. The AR glasses include an AR glasses frame 1 and eyeglasses temples connected to the AR glasses frame 1, the AR glasses frame 1 is any of the AR glasses frame 1 described above, or the AR glasses frame 1 is prepared by any of the method for preparing the AR glasses frame 1 described above. Since the AR glasses adopt all the technical solutions of all the aforementioned embodiments, they at least have the beneficial effects brought by the technical solutions of the aforementioned embodiments, which will not be described one by one here.

Certainly, the AR glasses further include lenses and components for realizing their AR functions, which will not be described here.

The above are only some embodiments of the present application, and are not intended to limit the scope of the present application. Under the application concept of the present application, any equivalent structure transformation made by using the description and accompanying drawings of the present application, or directly or indirectly applied in other related technical fields, is included within the scope of the present application.

What is claimed is:

1. An augmented reality (AR) glasses frame, comprising:
a main body, wherein the main body is made of magnesium-lithium alloy, and a shielding layer is provided at an inner side surface of the main body; and
an appearance part, wherein the appearance part is made of metal, the appearance part is connected to an outer side surface of the main body, and a decorative layer is provided at a surface of the appearance part away from the main body,
wherein a decorative protective layer is provided at peripheral side surfaces of the main body and the appearance part.

2. The AR glasses frame according to claim 1, wherein:
a thickness range of the appearance part is 0.02 mm to 0.2 mm; and/or
a thickness range of the main body is 0.4 mm to 0.6 mm.

3. The AR glasses frame according to claim 1, wherein an assembly part is connected to the inner side surface of the main body, and the shielding layer is provided at an inner side surface of the assembly part and the inner side surface of the main body.

4. The AR glasses frame according to claim 3, wherein:
a connection mode between the main body and the appearance part is hot rolling composite, welding or bonding; and/or
the assembly part and the main body are an integrated injection molding structure.

5. The AR glasses frame according to claim 3, wherein:
the appearance part is made of aluminum alloy, titanium alloy or stainless steel; and/or
the assembly part is made of plastic; and/or
the shielding layer is made of epoxy resin; and/or
the decorative layer is made of metal oxide or ceramic; and/or
the decorative protective layer is made of metal or resin material.

6. A method for preparing an augmented reality (AR) glasses frame, comprising:
providing a composite board comprising a main body and an appearance part stacked with the main body, wherein the main body is made of magnesium-lithium alloy, and the appearance part is made of metal;
stamping the composite board, and forming source material of a glasses frame;
spraying a shielding layer on a surface of the main body away from the appearance part;
performing surface treatment on a surface of the appearance part away from the main body, and forming a decorative layer; and
performing transition treatment on peripheral side surfaces of the main body and the appearance part, forming a decorative protective layer, and completing processing of the AR glasses frame.

7. The method for preparing the AR glasses frame according to claim 6, wherein after the stamping the composite board and forming the source material of the glasses frame, and before the spraying the shielding layer on the surface of the main body away from the appearance part, the method further comprises:
performing Nano injection molding on the source material of the glasses frame, and forming an assembly structure on the surface of the main body away from the appearance part.

8. The method for preparing the AR glasses frame according to claim 6, wherein:
the shielding layer is made of epoxy resin; and/or
the surface treatment comprises anodizing, electrolytic coloring or magnetron sputtering, and the decorative layer is made of metal oxide or ceramic; and/or
the decorative protective layer is made of metal or resin material.

9. The method for preparing the AR glasses frame according to claim 6, wherein after the performing the surface treatment on the surface of the appearance part away from the main body, and forming the decorative layer; and before the performing the transition treatment on the peripheral side surfaces of the main body and the appearance part, the method further comprises:
machining the source material of the glasses frame, and forming a cross section on the peripheral side surfaces of the main body and the appearance part; and
the performing the transition treatment on the peripheral side surfaces of the main body and the appearance part, forming the decorative protective layer is specifically to perform the transition treatment on the cross section.

10. The method for preparing the AR glasses frame according to claim 9, wherein the transition treatment comprises electroplating or electrophoresis.

11. The method for preparing the AR glasses frame according to claim 6, wherein:
the appearance part is made of aluminum alloy, titanium alloy or stainless steel; and/or
the assembly part is a plastic part.

12. An augmented reality (AR) glasses, comprising:
an AR glasses frame, and
eyeglasses temples connected to the AR glasses frame;
wherein the AR glasses frame is the AR glasses frame according to claim 1.

13. An augmented reality (AR) glasses, comprising:
an AR glasses frame, and
eyeglasses temples connected to the AR glasses frame;
wherein the AR glasses frame is prepared by the method for preparing the AR glasses frame according to claim 6.
